(19) United States
(12) Patent Application Publication
(10) Pub. No.: US 2024/0263662 A1
(43) Pub. Date: Aug. 8, 2024

(54) Fastener With Polygonal Counterbore Cutters

(71) Applicant: OMG, Inc., Agawam, MA (US)

(72) Inventor: Joseph Wetzel, Windsor, CT (US)

(21) Appl. No.: 18/428,113

(22) Filed: Jan. 31, 2024

Related U.S. Application Data
(60) Provisional application No. 63/483,547, filed on Feb. 7, 2023.

(51) Int. Cl. F16B 25/00

(52) U.S. Cl. CPC F16B 25/0057; F16B 25/0068; F16B 25/0015

(57) ABSTRACT

A fastener for use with building materials has an upper head with an underside with a plurality of cutters. The cutters are circumferentially spaced from each other with a respective cutout therebetween. The cutters or cutouts or both can have an irregular polygonal cross sectional shape. A lower shank extends from the head to a distal tip and includes threading on at least a portion thereof.

### CROSS-REFERENCE TO RELATED APPLICATION

This application claims priority to U.S. Provisional patent application No. 63/483,547 for “Fastener with Polygonal Counterbore Cutters”, filed on Feb. 7, 2023, the entire content of which is incorporated by reference.

### BACKGROUND

This disclosure relates to an improved fastener for building structures, and more particularly to a fastener that is suitable and effective for use with a variety of different materials and in different settings (i.e., a “multi-purpose” fastener or screw). More particularly, the disclosure relates to a countersinking multi-purpose fastener with an advantageous thread configuration and polygonal counterbore cutters in the head portion.

The disclosed embodiments have been shown to improve installation process by making it easier to install (i.e., less torquing force required to thread into a substrate) and yielding a clean counterbore with minimal or no visible substrate fibers. Additionally, the embodiments have shown efficacy with many different types of substrates and for making a wide variety of building member connections.

### SUMMARY

In one embodiment, a structural fastener for use with building materials includes an upper head and a lower shank. The upper head has a top and an underside with a plurality of cutters circumferentially spaced apart from each other with a cutout therebetween. Each cutter has an irregular polygonal cross-sectional shape. The lower shank extends from the head to a distal tip and includes threading on at least a portion thereof.

In another embodiment, a structural fastener for use with building materials includes an upper head and a lower shank. The upper head has a top and an underside with a plurality of cutters circumferentially spaced apart from each other with a cutout therebetween. Each cutter is dual sectional with an upper portion extending from a top to a bottom and a lower portion extending from a top to a bottom with the bottom of the upper section and top of the lower section sharing a common edge. The lower shank extends from the head to a distal tip and includes threading on at least a portion thereof. The bottom of the lower portion is wider than the top of the lower portion in each cutter.

In yet another embodiment, a structural fastener for use with building materials has an upper head and a shank. The upper head includes a top and an underside. The shank extends downward from the upper head and has at least a portion with threading. The underside of the upper head defines a plurality of cutters. Each cutter is defined between a leading surface defining a leading forward edge and an opposite trailing surface defining a trailing forward edge. The respective leading forward edge and trailing forward edge converge toward one another in a direction from the top of the head toward the shank.

### BRIEF DESCRIPTION OF DRAWINGS

FIG. 1 show various views of an embodiment of the disclosed fastener;

FIG. 2 is a cross-sectional view of the fastener of FIG. 1;

FIG. 3 is a cross-sectional view of the head portion of the disclosed fastener;

FIG. 4 show side and top views of the head portion of the disclosed fastener;

FIG. 5 is an elevation view of the disclosed fastener from the bottom upward;

FIG. 6 is another side elevation view of the head portion of the disclosed fastener;

FIG. 7 is a cross-sectional view of the head portion of the disclosed fastener;

FIG. 8 is an enlarged side elevation view of the head of the fastener;

FIG. 9 is a side cross-sectional view of the head of the fastener;

FIG. 10 is an elevation view from the tip of the fastener upwards, showing key details of the underside of the head; and

FIG. 11 is a side elevation view of the head, showing key exemplary dimensions.

### DISCLOSURE OF THE INVENTION

Among the benefits and improvements disclosed herein, other objects and advantages of the disclosed embodiments will become apparent from the following wherein like numerals represent like parts throughout the figures. Detailed embodiments of a fastener with polygonal cutters are disclosed; however, it is to be understood that the disclosed embodiments are merely illustrative of the invention that may be embodied in various forms. In addition, each of the examples given in connection with the various embodiments of the invention are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), although it may The phrases “in another embodiment” and “in some other embodiments” as used herein do not necessarily refer to a different embodiment, although it may Thus, as described below, various embodiments may be readily combined without departing from the scope or spirit of the invention.

In addition, as used herein, the term “or” is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

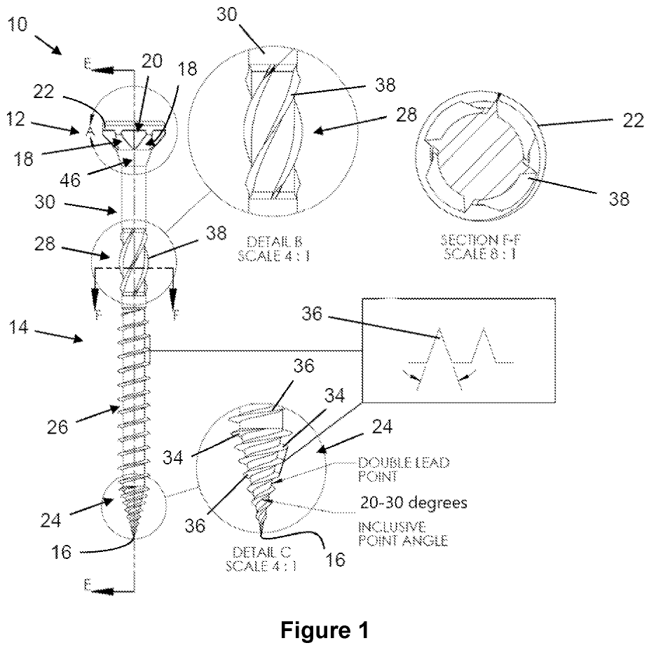

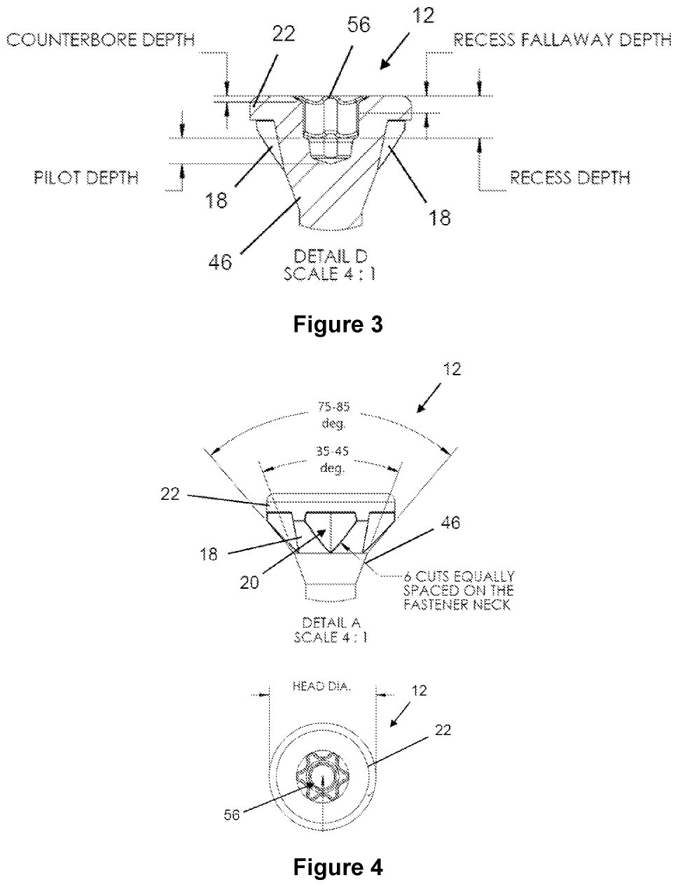

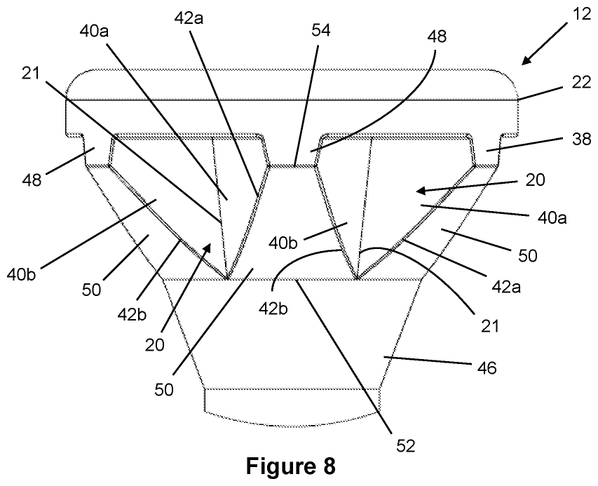

With reference to FIGS. 1-11, the disclosed multi-purpose countersinking fastener 10 comprises a head portion 12 and a shank portion 14 extending from the underside of the head to a distal tip 16. The head 12 includes a substantially flat disc-like top 22 and an underside with a plurality of polygonal cutters 18 defined between spaced apart cutouts 20, also having a polygonal shape. A smooth frustoconical section 46 transitions from the distal end of the cutters 18 to the proximal end of the shank 14.

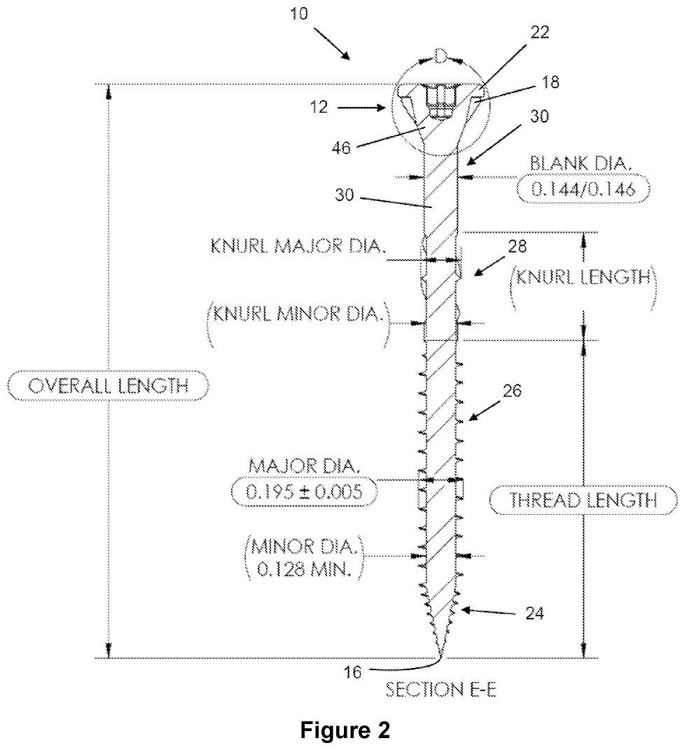

As shown, the shank 12 includes primary threading 26 on a proximal section and an unthreaded distal portion 30 with an abrasive cutting section (helical knurl) 28 therebetween. Additionally, the shank 12 includes a lead section 24 with a conical shape toward the tip with double threading, 34 and 36. In the disclosed embodiments, the tip 16 is provided with a sharp point to allow it to bore through the corresponding building material. The tip may also be a sharp gimlet tip such as one exhibiting a 20° to 30° included angle, however any suitable tip configured for boring through a material such as wood, for example, may be provided. As shown, the double threading extends from the pointed tip through the conical lead section 24 and the second thread 34 terminates at or near the top of the conical portion, at the interface edge between the lead section 24 and cylindrical section of the shank. The knurl section 28 includes a plurality of helical knurl threads 32 threaded in the opposite direction from and at fewer threads per inch (TPI) than the primary threads 36. FIG. 2 identifies exemplary major and minor diameters of the knurl section and primary threaded section, although these dimensions are non-limiting.

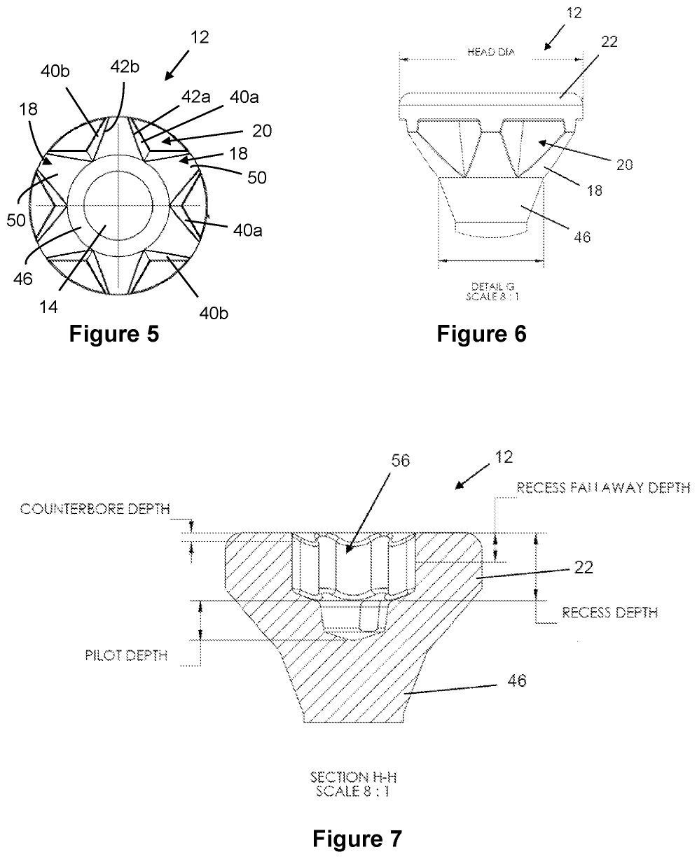

The head section comprises an upper flat disc-like section 22 with cutters 18 on the underside. The disc-like section defines a top surface that includes a drive system, which may be any drive system known in the art, including the depicted proprietary TORX® ttap® socket 56. In other embodiments, the head may be provided with other drive systems, such as a Phillips, flat, or square socket configuration, or alternatively with a hex-shape or similar. Ultimately, any suitable type of tool interface may be provided in the head. The cutters are defined between opposite leading and trailing surfaces, 40a and 40b, each defining a forward edge, 42a and 42b, respectively, that converge toward each other in the direction from the shank toward the disc-like top 22. Notably, the leading and trailing surfaces, 40a and 40b, do not completely converge or intersect, thus yielding a flat upper section 48 in each cutter 18 that leads from a lower section 50 to the top disc 22. As depicted, each of the lower cutter sections 50 is four-sided with a bottom side/edge 52 at the top edge of the frustoconical head section 46 and a top side/edge 54 that defines the interface with the upper cutter section 48. The top side/edge 54 of the bottom section also defines the bottom side/edge of the upper section 48, and the upper section 48 extends therefrom to the flat disc 22. As shown, the forward edges 42a and 42b of each cutter defined by the leading and trailing surfaces, 40a and 40b, connect to the top edge 54 and bottom edge 52 of each cutter lower section 50. As can also be seen most clearly in FIG. 5, the leading and trailing surfaces, 40a and 40b, are not configured completely upright, and rather transition slightly inward into their respective cutout 20 in the direction from the bottom towards the top, terminating at an upper/inner edge 23 at the disc-like top 22, and having an inner apex 21.

Each cutout 20 in the depicted preferred embodiment has an irregular pentagonal shape with a substantially flat top edge 44 formed by the bottom edge of the disc-like top 22 and defined between leading and trailing surfaces.

Preferred dimensions, angles and threading configurations are shown in the drawings. Of course, these data points are for a particularly preferred embodiment of the fastener 10 and not necessarily limiting. Generally, the given dimensions for each element, portion or section can be viewed most accurately relative to dimensions of the other elements, portions or sections. That is, the absolute dimensions shown in the drawings are not as important as the relative dimensions of the elements, portions and sections to one another. Additionally, other sizes up to a departure of approximately 50%, and more preferably approximately 25% are considered within an acceptable range for the inventive fastener. Fasteners with individual elements having dimensions relative to one another like or similar to those identified in FIGS. 1-11—especially ratios of edge and surface angles, and other dimensions in the head 12—have been shown to be particularly effective and well suited for the intended uses with numerous different building material substrates, including wooden and composites, for example.

The depicted preferred embodiment includes six substantially identical irregular polygonal cutters 18 equidistantly spaced about the central axis defined by the shank 14 by six substantially identical quasi-pentagonal cutouts 20.

This is best understood with reference to FIGS. 5 and 6. As noted, each cutter comprises a top section 48 and bottom section 50 that share an edge 54.

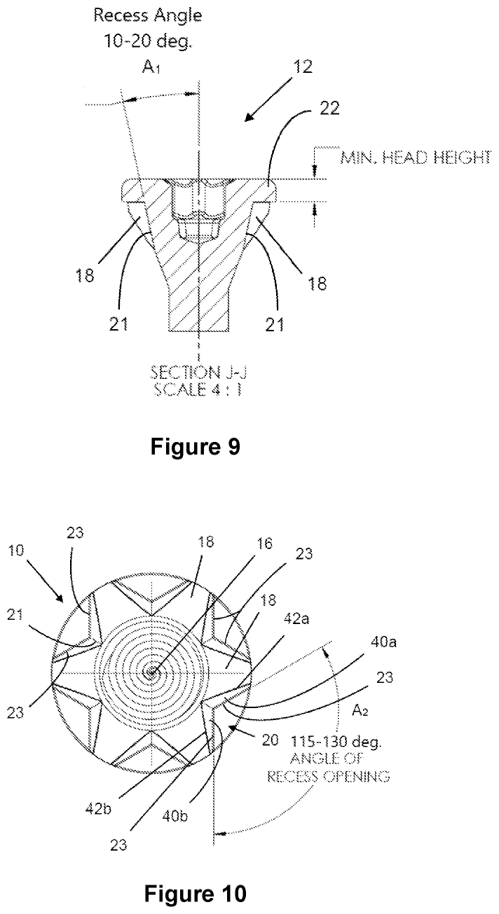

FIG. 9 shows additional details of the head 12, including specifically the exemplary preferred first recess angle A₁ , which is the angle between the inner apex 21 of each cutout 20 and the central axis of the fastener 10. The recess angle A₁ is preferably within an approximate range of 10°-20°. For example, embodiments exist with a recess angle A1 of 10°, 12°, 14°, 16°, 18° and 20°, and have shown to be effective.

FIG. 10 shows an exemplary second recess angle A₂ , which is the angle between opposite upper/inner edges 23 of each of the leading and trailing surfaces, 40a and 40b, of each cutout 20. Preferably, the second recess angle A2 is within an approximate range of 95°-160°, more preferably within an approximate range of 105°-140°, and more particularly 115°-130°. As shown, the depicted preferred embodiment includes a second recess angle A₂ of approximately 115-130°, which may be 115°, 116°, 117°, 118°, 119°, 120°, 121°, 122°, 123°, 124°, 125°, 126°, 127°, 128°, 129°or 130°.

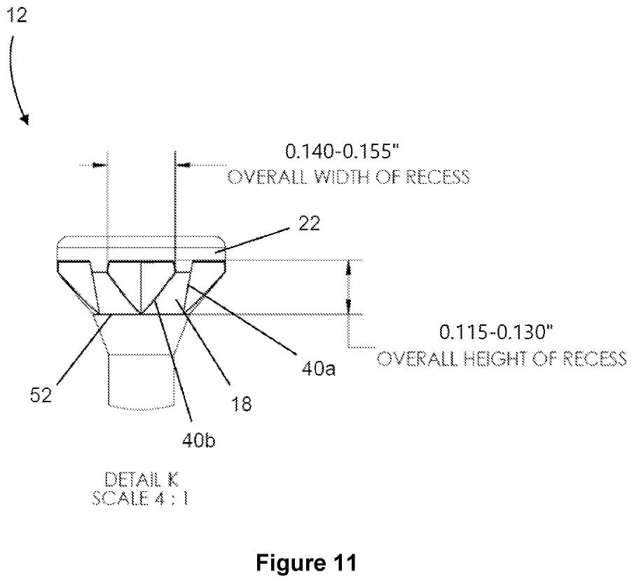

FIG. 11 shows additional preferred dimensions of portions of the head 12.

With reference to FIG. 2, in the preferred embodiment, the minor diameter of the knurl section 28 is slightly larger than the minor diameter of the primary threaded section 26; the major diameter of the knurl section 28 is less than the major diameter of the threaded section 26; the diameter of the unthreaded section 30 is greater than the minor diameter of the knurl section 28 and the minor diameter of the primary threaded section 26, and less than the major diameter of the knurl section and major diameter of the threaded section; and the axial length of the knurl section 28 is less than the axial length of the threaded section 26. Various non-limiting preferred dimensions are identified in FIG. 2.

Additionally, while a helical knurl section 28 proximally following the primary threaded section 26 is depicted, other abrasive surfaces, such as a diamond or straight knurled surface or other types of surface projections capable of grinding wood fibers during installation can be employed in place of the helical knurl within the context of the invention.

The depicted absolute and relative dimensions and structural relationships of the head 12 have shown particular efficacy at providing an effective and efficient installation into a variety of building material substrates, and cutting a clean counterbore. This is especially the case when combined with the depicted shank 14 with double lead threading, 34 and 36, at the conical lead section 24 toward the tip 16, followed by primary threaded section 26, knurled section 28 and unthreaded section 30. This yields building assemblies that are both structurally robust and aesthetically pleasing.

The fastener 10 can be made from carbon steel or any other suitable durable and hard material used for forming fasteners, typically metals. According to the various exemplary embodiments, the threads can be provided by using a thread cutting process, such as by using a split circular die held in a die stock, for example. As those skilled in the art understand, the fasteners may also be treated in any known manner to improve strength, hardness and corrosion resistive properties (i.e., heat treating, coating(s), etc.).

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A structural fastener for use with building materials, comprising:
an upper head with a top and an underside having a plurality of cutters circumferentially spaced apart from each other with a cutout therebetween, each cutter having an irregular polygonal cross sectional shape; and
a lower shank extending from the head to a distal tip and including threading on at least a portion thereof.

2. The fastener of claim 1, wherein each cutter includes a lower four-sided section in a direction toward the shank and an upper four-sided section extending from the lower four-sided section to the head top.

3. The fastener of claim 1, wherein each cutout has an irregular polygonal cross sectional shape.

4. The fastener of claim 3, wherein each cutout has at least four sides.

5. The fastener of claim 4, wherein each cutout has a pentagonal cross sectional shape.

6. The fastener of claim 1, wherein each cutout is delimited by a flat top edge proximate the top of the head.

7. The fastener of claim 1, wherein a cylindrical portion of the shank transitions conically to the tip, and the conical section comprises double helical threading.

8. The fastener of claim 1, wherein the shank includes a proximal unthreaded section, a distal threaded section and an intermediate knurl section between the unthreaded section and threaded section.

9. The fastener of claim 1, wherein
each cutout is defined between side walls;
each side wall defines a front edge that delimits a side of a cutter; and
the side walls converge inwardly toward each other.

10. The fastener of claim 1, wherein
each cutter is delimited circumferentially by a leading edge and a trailing edge; and
the leading edge and trailing edge of each cutter converge toward each other in a direction from the shank toward the top of the head.

11. The fastener of claim 1, wherein each cutter includes a bottom section and a top section.

12. The fastener of claim 11, wherein each of the top section and bottom section is quadrilateral.

13. The fastener of claim 1, comprising a frustoconical section between a bottom edge of the cutters and the shank.

14. The fastener of claim 1, wherein
the shank includes a primary threaded section distal of an abrasive section; and
the abrasive section has a minor diameter that is greater than a minor diameter of the primary threaded section.

15. A structural fastener for use with building materials, comprising:
an upper head with a top and an underside having a plurality of cutters circumferentially spaced apart from each other with a cutout therebetween, each cutter being dual sectional with an upper portion extending from a top to a bottom and a lower portion extending from a top to a bottom, wherein the bottom of the upper section and top of the lower section share a common edge; and
a lower shank extending from the head to a distal tip and including threading on at least a portion thereof, wherein
the bottom of the lower portion is wider than the top of the lower portion in each cutter.

16. The structural fastener of claim 15, wherein the top of the upper portion is coextensive with or wider than the bottom of the upper portion.

17. The structural fastener of claim 15, wherein the bottom of the lower portion is wider than the top of the upper portion.

18. The structural fastener of claim 15, wherein each cutout has an irregular polygonal cross sectional shape.

19. A structural fastener for use with building materials, comprising:
an upper head with a top and an underside;
a shank extending downward from the upper head and having at least a portion with threading, wherein
the underside of the upper head defines a plurality of cutters, each cutter defined between a leading surface defining a leading forward edge and an opposite trailing surface defining a trailing forward edge,
the respective leading forward edge and trailing forward edge converge toward one another in a direction from the top of the head toward the shank.

20. The structural fastener of claim 19, wherein the cutters are circumferentially spaced from one another via a cutout with a polygonal cross section having a flat top edge.
